(19) United States
(12) Patent Application Publication
(10) Pub. No.: US 2007/0121726 A1
(43) Pub. Date: May 31, 2007

(54) Motion estimator and motion estimating method

(75) Inventors: Ho-seop Lee, Seoul (KR); Jong-sul Min, Hwaseong-si (KR); Oh-jae Kwon, Anyang-si (KR); Myung-jac Kim, Anyang-si (KR); Hwa-seok Seong, Suwon-si (KR); Min-kyoung Cho, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/600,750

(22) Filed: Nov. 17, 2006

(30) Foreign Application Priority Data
Nov. 30, 2005 (KR) 2005-0115546

(51) Int. Cl. H04N 11/02; H04N 7/12

(52) U.S. Cl. 375/240.16; 375/240.26

(57) ABSTRACT

A motion estimator and a method of estimating motion are provided. The motion estimator comprises a candidate vector calculating unit for determining a plurality of candidate vectors for each block of a frame to be interpolated, on the basis of a current frame and a previous frame, a final motion deciding unit for selecting a candidate vector among the plurality of candidate vectors, according to a desired criteria, and for outputting the selected candidate vector as a final motion vector of a corresponding block and a global vector modeling unit for performing regression analysis based on final motion vectors to model a global vector calculating formula, and for providing the global vector calculating formula to the candidate vector calculating unit, wherein the candidate vector calculating unit calculates a global vector for each block of a next frame to be interpolated according to the modeled global vector calculating formula, and provides the global vector as one of the plurality of candidate vectors to the candidate vector deciding unit. Thus, exemplary embodiments of the present invention provide a motion estimator and a motion estimating method which are capable of obtaining a correct global vector while simplifying the configuration of the hardware.

### CROSS-REFERENCE TO RELATED APPLICATIONS

This application claims the benefit under 35 U.S.C. §119(a) of Korean Patent Application No. 2005-0115546, filed on Nov. 30, 2005, in the Korean Intellectual Property Office, the entire disclosure of which is hereby incorporated by reference.

### BACKGROUND OF THE INVENTION

1. Field of Invention

The present invention relates to a motion estimator and a motion estimating method. More particularly, the present invention relates to a motion estimator and a motion estimating method for modeling global motion.

2. Description of the Related Art

A conventional method for modeling global motion will be described with reference to FIGS. 1A and 1B.

As illustrated in FIG. 1A, in order to estimate motion of a frame by interpolation, a plurality of candidate vectors are calculated on the basis of a current frame and a previous frame. The candidate vectors can be variously selected. As illustrated in FIG. 1A, the candidate vectors can include a vector SL of a block B adjacent to a current block A, a vector SR of a block C adjacent to the current block A, vectors TR and TL of the previous frame, a zero vector T, a global vector, and the like.

A motion vector for a block to be interpolated is selected according to a predetermined cost function. Then, data of the corresponding block is interpolated using the selected motion vector.

Here, the global vector, which is one of the candidate vectors, is obtained by the following Equation 1.

$$C ( X , n ) = [ \begin{matrix}{p}_{1} ( n ) + {p}_{3} ( n ) X \\ {p}_{2} ( n ) + {p}_{4} ( n ) X ,\end{matrix} \qquad ( 1 )$$

Where, n represents an n-th frame, x and y respectively represent x and y coordinates of the corresponding block, p1 and p2 represent panning factors, and p3 and p4 represent zooming factors.

In order to obtain the global vector, as illustrated in FIG. 1B, some of the motion vectors are sampled. An example where 9 motion vectors are sampled is described. By substituting the resultant sampled data pairs (V1, V2), (V1, V3), (V2, V3), (V4, V5), (V4, V6), (V5, V6), (V7, V8), (V7, V9), (V8, V9), (V1, V4), (V1, V7), (V4, V7), (V2, V5), (V2, V8), (V5, V8), (V3, V6), (V3, V9), (V6, V9) into equation 1, 18 values which can be p1, p2, p3 and p4 are obtained. Then, median filtering is performed on the 18 values, thereby finally deciding p1, p2, p3, and p4.

However, in the conventional method for obtaining a global vector, since a limited number of motion vectors are sampled, errors are significant when incorrect vectors are sampled, which can make the obtained global vector incorrect. Further, if the number of samples increases in order to solve the problem, more calculators and complicated calculations are required so that the configuration of the hardware may be complicated and more expensive.

Accordingly, there is a need for an improved apparatus and method for estimating motion.

### SUMMARY OF THE INVENTION

Exemplary embodiments of the present invention address at least the above problems and/or disadvantages and provide at least the advantages described below. Accordingly, it is an exemplary aspect of the present invention to provide a motion estimator and a motion estimating method which are capable of obtaining a correct global vector while simplifying the configuration of the hardware.

The foregoing and/or other exemplary aspects of the present invention can be achieved by providing a motion estimator comprising a candidate vector calculating unit for determining a plurality of candidate vectors for each block of a frame to be interpolated, on the basis of a current frame and a previous frame, a final motion deciding unit for selecting a candidate vector among the plurality of candidate vectors according to a desired criteria and for outputting the selected candidate vector as a final motion vector of a corresponding block, and a global vector modeling unit for performing regression analysis based on final motion vectors to model a global vector calculating formula and for providing the global vector calculating formula to the candidate vector calculating unit, wherein the candidate vector calculating unit calculates a global vector for each block of a next frame to be interpolated according to the modeled global vector calculating formula, and provides the global vector as one of the plurality of candidate vectors to the candidate vector deciding unit.

According to another exemplary aspect of the present invention, the global vector modeling unit samples the final motion vectors to model the global vector calculating formula.

According to another exemplary aspect of the present invention, the global vector modeling unit models the global vector calculating formula through a linear regression analysis method.

According to another exemplary aspect of the present invention, the global vector calculating formula is modeled as follows:
Mvₓ=aₓx+bₓ
Mv_{y}=a_{y}y+b_{y},

wherein

$$[ \begin{matrix}{a}_{x} \\ {b}_{x}\end{matrix} ] = \frac{1}{n {\sum }_{k = 1}^{n} {x}_{k}^{2} - {( {\sum }_{k = 1}^{n} {x}_{k} )}^{2}} [ \begin{matrix}n & - {\sum }_{k = 1}^{n} {x}_{k} \\ - {\sum }_{k = 1}^{n} {x}_{k} & {\sum }_{k = 1}^{n} {x}_{k}^{2}\end{matrix} ] [ \begin{matrix}{\sum }_{k = 1}^{n} {x}_{k} Mv {x}_{k} \\ {\sum }_{k = 1}^{n} Mv {x}_{k}\end{matrix} ] \\ [ \begin{matrix}{a}_{y} \\ {b}_{y}\end{matrix} ] = \frac{1}{n {\sum }_{k = 1}^{n} {y}_{k}^{2} - {( {\sum }_{k = 1}^{n} {y}_{k} )}^{2}} [ \begin{matrix}n & - {\sum }_{k = 1}^{n} {y}_{k} \\ - {\sum }_{k = 1}^{n} {y}_{k} & {\sum }_{k = 1}^{n} {y}_{k}^{2}\end{matrix} ] [ \begin{matrix}{\sum }_{k = 1}^{n} {x}_{k} Mv {y}_{k} \\ {\sum }_{k = 1}^{n} Mv {y}_{k}\end{matrix} ] ,$$

where, Mvx and Mvy, which are global vectors, respectively represent an x-directional motion value and a y-directional motion value, x and y are respectively index values of x and y coordinates of the block, ax and ay are respectively an x-directional zooming factor and a y-directional zooming factor, and bx and by are respectively an x-directional panning factor and a y-direction panning factor.

According to another exemplary aspect of the present invention, the motion estimator further comprises a frame interpolating unit for interpolating an intermediate frame to be inserted between the current frame and the previous frame, according to the final motion vector.

According to another exemplary aspect of the present invention, the final motion deciding unit comprises a candidate vector selector selecting a candidate vector among the plurality of candidate vectors, and a vector compensator for compensating the candidate vector selected by the candidate vector selector and outputting the compensated candidate vector as the final motion vector.

The foregoing and/or other aspects of the present invention can be achieved by providing a motion estimating method comprising determining a plurality of candidate vectors for each of blocks of a frame to be interpolated, on the basis of a current frame and a previous frame, selecting a candidate vector among the plurality of candidate vectors according to a desired criteria, outputting the selected candidate vector as a final motion vector of a corresponding block, performing regression analysis based on the final motion vectors to model a global vector calculating formula and providing the global vector calculating formula to the candidate vector calculating unit, wherein the determining the plurality of candidate vectors comprises determining a global vector for each block of a next frame to be interpolated, according to the global vector calculating formula, and providing the global vector as the candidate vector of the plurality of candidate vectors to the candidate vector deciding unit.

According to another exemplary aspect of the present invention, in the modeling of the global vector calculating formula, the global vector calculating formula is modeled by sampling the final motion vectors.

According to another exemplary aspect of the present invention, in the modeling of the global vector calculating formula, the global vector calculating formula is modeled through a linear regression analysis method.

According to another exemplary aspect of the present invention, the global vector calculating formula is modeled as follows:
Mvₓ=aₓx+bₓ
Mv_{y}=a_{y}y+b_{y},

wherein,

$$[ \begin{matrix}{a}_{x} \\ {b}_{x}\end{matrix} ] = \frac{1}{n {\sum }_{k = 1}^{n} {x}_{k}^{2} - {( {\sum }_{k = 1}^{n} {x}_{k} )}^{2}} [ \begin{matrix}n & - {\sum }_{k = 1}^{n} {x}_{k} \\ - {\sum }_{k = 1}^{n} {x}_{k} & {\sum }_{k = 1}^{n} {x}_{k}^{2}\end{matrix} ] [ \begin{matrix}{\sum }_{k = 1}^{n} {x}_{k} Mv {x}_{k} \\ {\sum }_{k = 1}^{n} Mv {x}_{k}\end{matrix} ] \\ [ \begin{matrix}{a}_{y} \\ {b}_{y}\end{matrix} ] = \frac{1}{n {\sum }_{k = 1}^{n} {y}_{k}^{2} - {( {\sum }_{k = 1}^{n} {y}_{k} )}^{2}} [ \begin{matrix}n & - {\sum }_{k = 1}^{n} {y}_{k} \\ - {\sum }_{k = 1}^{n} {y}_{k} & {\sum }_{k = 1}^{n} {y}_{k}^{2}\end{matrix} ] [ \begin{matrix}{\sum }_{k = 1}^{n} {x}_{k} Mv {y}_{k} \\ {\sum }_{k = 1}^{n} Mv {y}_{k}\end{matrix} ] ,$$

where, Mvx and Mvy, which are global vectors, respectively represent an x-directional motion value and a y-directional motion value, x and y are respectively index values of x and y coordinates of the block, ax and ay are respectively an x-directional zooming factor and a y-directional zooming factor, and bx and by are respectively an x-directional panning factor and a y-direction panning factor.

According to another exemplary aspect of the present invention, the method further comprises interpolating an intermediate frame to be inserted between the current frame and the previous frame, according to the compensated final motion vector.

According to another exemplary aspect of the present invention, the outputting of the final motion vector comprises selecting a candidate vector among the plurality of candidate vectors, compensating the selected candidate vector and outputting the compensated candidate vector as the final motion vector.

The foregoing and/or other exemplary aspects of the present invention can be achieved by providing a global motion estimator comprising a motion estimating unit for estimating a motion vector for each block of a frame to be interpolated, on the basis of a current frame and a previous frame, a global modeling unit for performing regression analysis based on the estimated motion vector and for modeling a global vector calculating formula and a global vector calculating unit for calculating a global vector for each block of a next frame to be interpolated, according to the global vector calculating formula.

According to another exemplary aspect of the present invention, the global modeling unit models the global vector calculating formula by sampling the motion vectors.

According to another exemplary aspect of the present invention, the global modeling unit models the global vector calculating formula through a linear regression analysis method.

According to another exemplary aspect of the present invention, the global vector calculating formula is modeled as follows:
Mvₓ=aₓx+bₓ
Mv_{y}=a_{y}y+b_{y},

wherein,

$$[ \begin{matrix}{a}_{x} \\ {b}_{x}\end{matrix} ] = \frac{1}{n {\sum }_{k = 1}^{n} {x}_{k}^{2} - {( {\sum }_{k = 1}^{n} {x}_{k} )}^{2}} [ \begin{matrix}n & - {\sum }_{k = 1}^{n} {x}_{k} \\ - {\sum }_{k = 1}^{n} {x}_{k} & {\sum }_{k = 1}^{n} {x}_{k}^{2}\end{matrix} ] [ \begin{matrix}{\sum }_{k = 1}^{n} {x}_{k} Mv {x}_{k} \\ {\sum }_{k = 1}^{n} Mv {x}_{k}\end{matrix} ] \\ [ \begin{matrix}{a}_{y} \\ {b}_{y}\end{matrix} ] = \frac{1}{n {\sum }_{k = 1}^{n} {y}_{k}^{2} - {( {\sum }_{k = 1}^{n} {y}_{k} )}^{2}} [ \begin{matrix}n & - {\sum }_{k = 1}^{n} {y}_{k} \\ - {\sum }_{k = 1}^{n} {y}_{k} & {\sum }_{k = 1}^{n} {y}_{k}^{2}\end{matrix} ] [ \begin{matrix}{\sum }_{k = 1}^{n} {x}_{k} Mv {y}_{k} \\ {\sum }_{k = 1}^{n} Mv {y}_{k}\end{matrix} ] ,$$

where, Mvx and Mvy, which are global vectors, respectively represent an x-directional motion value and a y-directional motion value, x and y are respectively index values of x and y coordinates of the block, ax and ay are respectively an x-directional zooming factor and a y-directional zooming factor, and bx and by are respectively an x-directional panning factor and a y-direction panning factor.

### BRIEF DESCRIPTION OF THE DRAWINGS

The above and/or other exemplary aspects and advantages of the prevent invention will become apparent and more readily appreciated from the following description of the exemplary embodiments, taken in conjunction with the accompany drawings, in which:

FIGS. 1A and 1B are views for explaining a conventional method for estimating a motion vector.

FIG. 2 is a control block diagram of a motion estimator according to an exemplary embodiment of the present invention; and

FIG. 3 is a flowchart illustrating a motion estimating method according to an exemplary embodiment of the present invention.

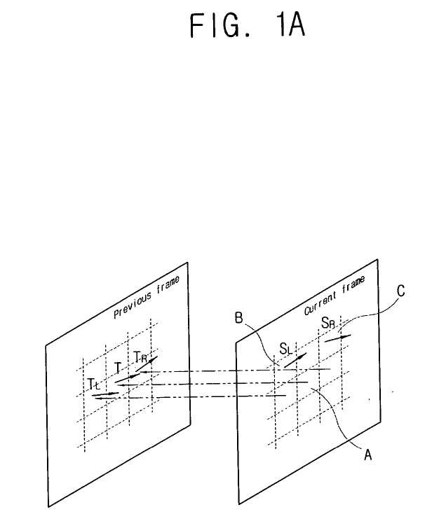

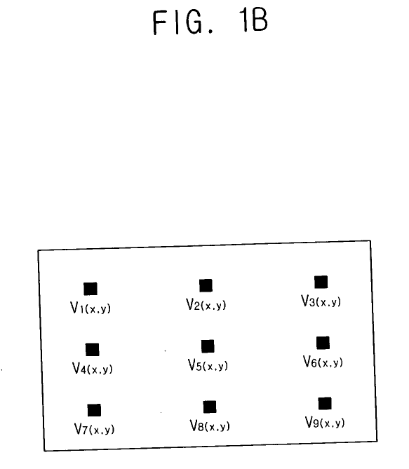

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Reference will now be made in detail to exemplary embodiments of the present invention which are illustrated in the accompanying drawings.

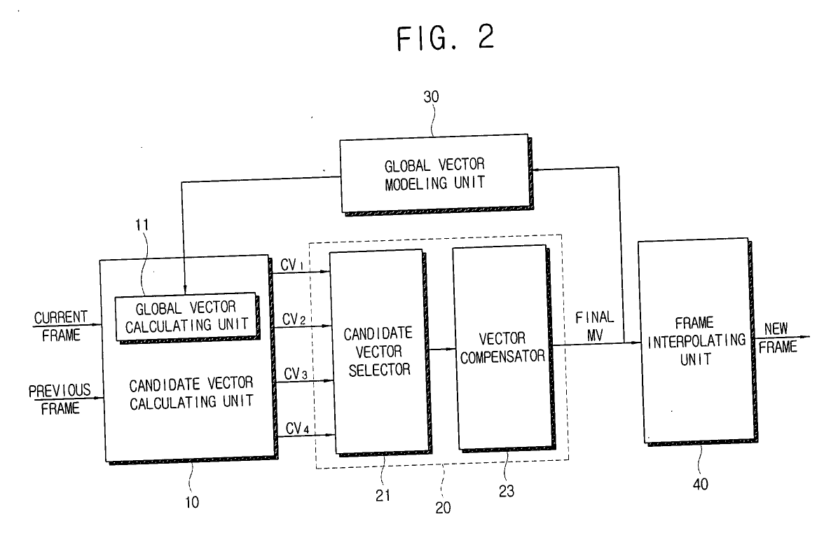

FIG. 2 is a control block diagram of a motion estimator according to an exemplary embodiment of the present invention. Referring to FIG. 2, the motion estimator includes a candidate vector calculating unit 10, a final motion deciding unit 20, and a global vector modeling unit 30.

The candidate vector calculating unit 10 determines a plurality of candidate vectors on the basis of a current frame and a previous frame. The candidate vector calculating unit 10 may include one or more candidate vector calculators corresponding to the respective candidate vectors.

For example, the candidate vector calculators may divide the current frame into a plurality of blocks, apply a Full Search Block Matching (FSBM) algorithm to a desired search region of the previous frame corresponding to a reference block to thus determine a plurality of motion prediction error values, and then estimate candidate vectors of the respective blocks on the basis of locations having minimum motion prediction error values. Here, the motion prediction error values can be determined by various methods, such as Sum of Absolute Difference (SAD), Mean Absolute Difference (MAD), and the like.

The candidate vector calculating unit 10 may include a global vector calculating unit 11 for determining a global vector of each block according to a global vector calculating formula modeled by the global vector modeling unit 30 which will be described later. The global vector calculating unit 11 determines a global vector of each block by substituting an index of each block into the modeled global vector calculating formula.

The candidate vector calculating unit 10 may generate motion vectors of blocks adjacent to the reference block of a current frame and/or motion vectors of blocks adjacent to the reference block of the previous frame as candidate vectors.

The candidate vectors are referred to as CV1, CV2, CV3, CV4, . . . as shown in FIG. 2.

The final motion deciding unit 20 selects one of the candidate vectors output from the candidate vector calculating unit 10, and outputs it as a final motion vector of a block to be interpolated. At this time, the final motion deciding unit 20 selects a candidate vector according to a desired criteria. For example, the final motion deciding unit 20 substitutes the respective candidate vectors in the cost function, and selects a candidate vector for which the value of the cost function is minimum. However, exemplary embodiments of the present invention are not limited to this, and various error analysis methods can be applied.

The final motion deciding unit 20 according to an exemplary embodiment of the present invention may include a candidate vector selector 21 for selecting one of the plurality of candidate vectors according to the desired criteria as described above, and a vector compensator 23 for compensating the selected vector.

Here, the vector compensator 23 compensates the selected motion vector in order to minimize a specific pattern or a blocking artifact. Various compensation methods can be used to compensate the motion vector. Here, the vector compensator 23 may be included in the candidate vector calculating unit 10 as well as the final motion deciding unit 20 so as to compensate the calculated respective candidate vectors.

The final motion vector decided by the final motion deciding unit 20 is output to the global vector modeling unit 30. The global vector modeling unit 30 performs regression analysis based on the final motion vector and models or determines a global vector calculating formula.

The global vector calculating formula is defined in equation 2.
Mvₓ=aₓx+bₓ
Mv_{y}=a_{y}y+b_{y},

where, Mvx and Mvy, which are global vectors, respectively represent an x-directional motion value and a y-directional motion value, x and y are respectively index values of x and y coordinates of a block, ax and ay are respectively an x-directional zooming factor and a y-directional zooming factor, and bx and by are respectively an x-directional panning factor and a y-direction panning factor.

For example, when resolution of an image frame is 720×480 and the size of a reference block is 16×16, the range of x of the image frame is 0-45, the range of y of the image frame is 1-29, and the image frame is divided into 1380 blocks.

If final motion vectors of the respective blocks are compensated by the vector compensator 23, equation 2 can be rewritten for the respective blocks, as the following equation 3.
Mvx₀=aₓ·0+bₓ Mvy₀=a_{y}·0+b_{y}
Mvx₁=aₓ·1+bₓ Mvy₁=a_{y}·1+b_{y}
. . .
Mvx₁₃₇₈=aₓ·1378+bₓ. Mvy₁₃₇₈=a_{y}·1378+b_{y}
Mvx₁₃₇₉=aₓ·1379+bₓ Mvy₁₃₇₉=a_{y}·1379+b_{y} (3)

If n blocks exist, equation 3 can be rewritten as equation 4 which is a general formula.
Mvx₀=aₓ·0+bₓ Mvy₀=a_{y}·0+b_{y}
Mvx₁=aₓ·1+bₓ Mvy₁=a_{y}·1+b_{y}
. . .
Mvxₙ₋₂=aₓ·(n−2)+bₓ Mvyₙ₋₂=a_{y}·(n−2)+b_{y}
Mvxₙ₋₁=aₓ·(n−1)+bₓ Mvyₙ₋₁=a_{y}·(n−1)+b_{y} (4)

Meanwhile, equation 4 can be expressed by the following equation 5 which is a matrix.

$$[ \begin{matrix}Mv {x}_{0} \\ ⋮ \\ Mv {x}_{n - 1}\end{matrix} ] = [ \begin{matrix}0 & 1 \\ ⋮ & 1 \\ n - 1 & 1\end{matrix} ] [ \begin{matrix}{a}_{x} \\ {b}_{x}\end{matrix} ] \\ [ \begin{matrix}Mv {y}_{0} \\ ⋮ \\ Mv {y}_{n - 1}\end{matrix} ] = [ \begin{matrix}0 & 1 \\ ⋮ & 1 \\ n - 1 & 1\end{matrix} ] [ \begin{matrix}{a}_{y} \\ {b}_{y}\end{matrix} ] \qquad ( 5 )$$

Equation 5 can be rewritten as equation 7 by applying equation 6 with respect to ax and bx.
(Ax=b→x=(A^{T}A)⁻¹(A^{T}b)) (6)

$$[ \begin{matrix}{a}_{x} \\ {b}_{x}\end{matrix} ] = \frac{1}{n {\sum }_{k = 1}^{n} {x}_{k}^{2} - {( {\sum }_{k = 1}^{n} {x}_{k} )}^{2}} [ \begin{matrix}n & - {\sum }_{k = 1}^{n} {x}_{k} \\ - {\sum }_{k = 1}^{n} {x}_{k} & {\sum }_{k = 1}^{n} {x}_{k}^{2}\end{matrix} ] [ \begin{matrix}{\sum }_{k = 1}^{n} {x}_{k} Mv {x}_{k} \\ {\sum }_{k = 1}^{n} Mv {x}_{k}\end{matrix} ] \qquad ( 7 )$$

Likewise, ay and by can be obtained by the following Equation 8.

$$[ \begin{matrix}{a}_{y} \\ {b}_{y}\end{matrix} ] = \frac{1}{n {\sum }_{k = 1}^{n} {y}_{k}^{2} - {( {\sum }_{k = 1}^{n} {y}_{k} )}^{2}} [ \begin{matrix}n & - {\sum }_{k = 1}^{n} {y}_{k} \\ - {\sum }_{k = 1}^{n} {y}_{k} & {\sum }_{k = 1}^{n} {y}_{k}^{2}\end{matrix} ] [ \begin{matrix}{\sum }_{k = 1}^{n} {x}_{k} Mv {y}_{k} \\ {\sum }_{k = 1}^{n} Mv {y}_{k}\end{matrix} ] \qquad ( 8 )$$

As seen in equations 7 and 8, ax, ay, bx, and by can be obtained through the index and motion value of the corresponding block. Accordingly, complicated calculations are not required, and correct global vectors can be obtained because coefficient values are obtained from motion vectors of entire blocks, differently from the conventional method. Meanwhile, the global vector calculating formula can be obtained by sampling a desired number of blocks without using motion vectors of entire blocks. In the conventional global vector calculator, increasing the number of samplings puts a greater load on hardware. However, in exemplary embodiments of the present invention, an increase in the number of samplings does not have the same negative influence on hardware.

The global vector calculating formula modeled by the global vector modeling unit 30 is provided to the candidate vector calculating unit 10. The global vector calculating unit 11 determines a global vector by substituting index values of x and y coordinates of a block to the global vector calculating formula. The resultant global vector is provided as one of the plurality of candidate vectors to the final motion deciding unit 20. Here, the global vector calculating formula modeled by the global vector modeling unit 30 is used to obtain global vectors of a next frame.

Meanwhile, the final motion vector decided by the final motion deciding unit 20 is used to generate a new intermediate frame in a frame interpolating unit 40. That is, the frame interpolating unit 40 interpolates the new intermediate frame to be inserted between the current frame and the previous frame, on the basis of the final motion vector.

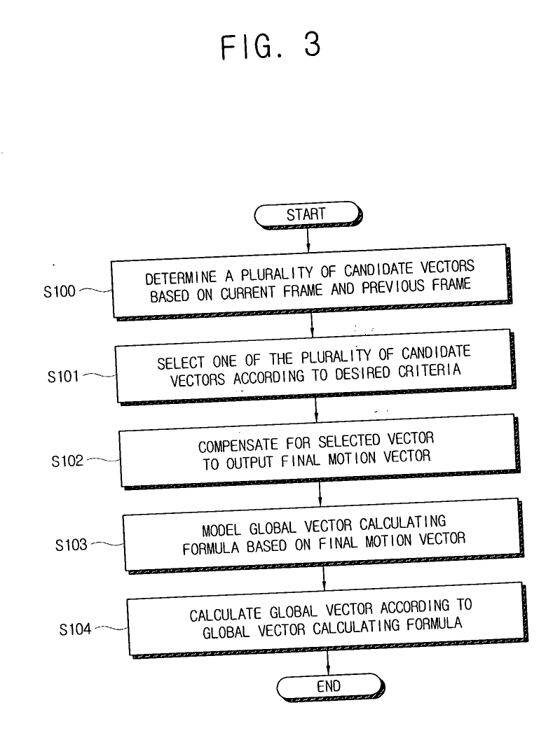

Hereinafter, an exemplary method for calculating a global vector in the motion estimator illustrated in FIG. 2 will be described with reference to FIG. 3.

Referring to FIGS. 2 and 3, the candidate vector calculating unit 10 determines a plurality of candidate vectors on the basis of the current frame and the previous frame (S100). Then, the candidate vector selector 21 selects one of the plurality of candidate vectors according to a desired criteria (S101). The selected motion vector is processed by the vector compensator 23 and is output as a final motion vector (S102).

Then, the global vector modeling unit 30 models the global vector calculating formula on the basis of the final motion vectors (S103). Details therefor will be not described as they have been described above. The global vector calculating unit 11 determines global vectors of a next frame according to the global vector calculating formula (S104). The calculated global vector may be provided as one of the plurality of candidate vectors.

As described above, according to exemplary embodiments of the present invention, there are provided a motion estimator and a motion estimating method which are capable of obtaining correct global vectors while simplifying the configuration of the hardware.

Certain exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A motion estimator comprising:
a candidate vector calculating unit for determining a plurality of candidate vectors for each block of a frame to be interpolated, on the basis of a current frame and a previous frame;
a final motion deciding unit for selecting a candidate vector from among the plurality of candidate vectors, according to a desired criteria, and for outputting the selected candidate vector as a final motion vector of a corresponding block; and
a global vector modeling unit for performing regression analysis based on a plurality of final motion vectors output by the final motion deciding unit to determine a global vector calculating formula, and for providing the global vector calculating formula to the candidate vector calculating unit,
wherein the candidate vector calculating unit calculates a global vector for each block of a next frame to be interpolated according to the global vector calculating formula, and provides the global vector as one of the plurality of candidate vectors to the candidate vector deciding unit.

2. The motion estimator according to claim 1, wherein the global vector modeling unit samples the plurality of final motion vectors to determine the global vector calculating formula.

3. The motion estimator according to claim 2, wherein the global vector modeling unit determines the global vector calculating formula through a linear regression analysis method.

4. The motion estimator according to claim 3, wherein the global vector calculating formula is determined as follows:
Mvₓ=aₓx+bₓ
Mv_{y}=a_{y}y+b_{y},
wherein
$$[ \begin{matrix}{a}_{x} \\ {b}_{x}\end{matrix} ] = \frac{1}{n {\sum }_{k = 1}^{n} {x}_{k}^{2} - {( {\sum }_{k = 1}^{n} {x}_{k} )}^{2}} [ \begin{matrix}n & - {\sum }_{k = 1}^{n} {x}_{k} \\ - {\sum }_{k = 1}^{n} {x}_{k} & {\sum }_{k = 1}^{n} {x}_{k}^{2}\end{matrix} ] [ \begin{matrix}{\sum }_{k = 1}^{n} {x}_{k} Mv {x}_{k} \\ {\sum }_{k = 1}^{n} Mv {x}_{k}\end{matrix} ] \\ [ \begin{matrix}{a}_{y} \\ {b}_{y}\end{matrix} ] = \frac{1}{n {\sum }_{k = 1}^{n} {y}_{k}^{2} - {( {\sum }_{k = 1}^{n} {y}_{k} )}^{2}} [ \begin{matrix}n & - {\sum }_{k = 1}^{n} {y}_{k} \\ - {\sum }_{k = 1}^{n} {y}_{k} & {\sum }_{k = 1}^{n} {y}_{k}^{2}\end{matrix} ] [ \begin{matrix}{\sum }_{k = 1}^{n} {x}_{k} Mv {y}_{k} \\ {\sum }_{k = 1}^{n} Mv {y}_{k}\end{matrix} ] ,$$
where, Mvx and Mvy, which are global vectors, respectively represent an x-directional motion value and a y-directional motion value, x and y are respectively index values of x and y coordinates of the block, ax and ay are respectively an x-directional zooming factor and a y-directional zooming factor, and bx and by are respectively an x-directional panning factor and a y-direction panning factor.

5. The motion estimator according to claim 4, further comprising a frame interpolating unit for interpolating an intermediate frame to be inserted between the current frame and the previous frame, according to the final motion vector.

6. The motion estimator according to claim 5, wherein the final motion deciding unit comprises a candidate vector selector for selecting a candidate vector among the plurality of candidate vectors, and a vector compensator for compensating the candidate vector selected by the candidate vector selector and for outputting the compensated candidate vector as the final motion vector.

7. A motion estimating method comprising:
calculating, by a candidate vector calculating unit, a plurality of candidate vectors for each of a plurality of blocks of a frame to be interpolated, on the basis of a current frame and a previous frame;
selecting a candidate vector for each of the plurality of blocks from among the plurality of candidate vectors according to a desired criteria:
outputting the selected candidate vectors for each of the plurality of blocks as a final motion vector of a corresponding block;
performing regression analysis based on the final motion vectors to determine a global vector calculating formula; and
providing the global vector calculating formula to the candidate vector calculating unit,
wherein the calculating the plurality of candidate vectors comprises calculating a global vector for each block of a next frame to be interpolated, according to the global vector calculating formula, and providing the global vector as a candidate vector of the plurality of candidate vectors to the candidate vector deciding unit.

8. The motion estimating method according to claim 7, wherein, in the performing the regression analysis to determine the global vector calculating formula, the global vector calculating formula is determined by sampling the final motion vectors.

9. The motion estimating method according to claim 8, wherein, in the performing the regression analysis to determine the global vector calculating formula, the global vector calculating formula is determined through a linear regression analysis method.

10. The motion estimating method according to claim 9, wherein the global vector calculating formula is determined as follows:
Mvₓ=aₓx+bₓ
Mv_{y}=a_{y}y+b_{y},
wherein,
$$[ \begin{matrix}{a}_{x} \\ {b}_{x}\end{matrix} ] = \frac{1}{n {\sum }_{k = 1}^{n} {x}_{k}^{2} - {( {\sum }_{k = 1}^{n} {x}_{k} )}^{2}} [ \begin{matrix}n & - {\sum }_{k = 1}^{n} {x}_{k} \\ - {\sum }_{k = 1}^{n} {x}_{k} & {\sum }_{k = 1}^{n} {x}_{k}^{2}\end{matrix} ] [ \begin{matrix}{\sum }_{k = 1}^{n} {x}_{k} Mv {x}_{k} \\ {\sum }_{k = 1}^{n} Mv {x}_{k}\end{matrix} ] \\ [ \begin{matrix}{a}_{y} \\ {b}_{y}\end{matrix} ] = \frac{1}{n {\sum }_{k = 1}^{n} {y}_{k}^{2} - {( {\sum }_{k = 1}^{n} {y}_{k} )}^{2}} [ \begin{matrix}n & - {\sum }_{k = 1}^{n} {y}_{k} \\ - {\sum }_{k = 1}^{n} {y}_{k} & {\sum }_{k = 1}^{n} {y}_{k}^{2}\end{matrix} ] [ \begin{matrix}{\sum }_{k = 1}^{n} {x}_{k} Mv {y}_{k} \\ {\sum }_{k = 1}^{n} Mv {y}_{k}\end{matrix} ] ,$$
where, Mvx and Mvy, which are global vectors, respectively represent an x-directional motion value and a y-directional motion value, x and y are respectively index values of x and y coordinates of the block, ax and ay are respectively an x-directional zooming factor and a y-directional zooming factor, and bx and by are respectively an x-directional panning factor and a y-direction panning factor.

11. The motion estimating method according to claim 10, wherein the outputting of the final motion vector comprises compensating the selected candidate vector and outputting the compensated candidate vector as the final motion vector.

12. The motion estimating method according to claim 11, further comprising:
interpolating an intermediate frame to be inserted between the current frame and the previous frame, according to the compensated final motion vector.

13. A global motion estimator comprising:
a motion estimating unit for respectively estimating a plurality of motion vectors for a plurality of blocks of a frame to be interpolated, on the basis of a current frame and a previous frame;
a global modeling unit for performing regression analysis based on the estimated motion vectors and for determining a global vector calculating formula; and
a global vector calculating unit for calculating a global vector for each block of a next frame to be interpolated, according to the global vector calculating formula.

14. The global motion estimator according to claim 13, wherein the global modeling unit determines the global vector calculating formula by sampling the plurality of motion vectors.

15. The global motion estimator according to claim 14, wherein the global modeling unit determines the global vector calculating formula through a linear regression analysis method.

16. The global motion estimator according to claim 15, wherein the global vector calculating formula is determined as follows:
Mvₓ=aₓx+bₓ
Mv_{y}=a_{y}y+b_{y},
wherein,
$$[ \begin{matrix}{a}_{x} \\ {b}_{x}\end{matrix} ] = \frac{1}{n {\sum }_{k = 1}^{n} {x}_{k}^{2} - {( {\sum }_{k = 1}^{n} {x}_{k} )}^{2}} [ \begin{matrix}n & - {\sum }_{k = 1}^{n} {x}_{k} \\ - {\sum }_{k = 1}^{n} {x}_{k} & {\sum }_{k = 1}^{n} {x}_{k}^{2}\end{matrix} ] [ \begin{matrix}{\sum }_{k = 1}^{n} {x}_{k} Mv {x}_{k} \\ {\sum }_{k = 1}^{n} Mv {x}_{k}\end{matrix} ] \\ [ \begin{matrix}{a}_{y} \\ {b}_{y}\end{matrix} ] = \frac{1}{n {\sum }_{k = 1}^{n} {y}_{k}^{2} - {( {\sum }_{k = 1}^{n} {y}_{k} )}^{2}} [ \begin{matrix}n & - {\sum }_{k = 1}^{n} {y}_{k} \\ - {\sum }_{k = 1}^{n} {y}_{k} & {\sum }_{k = 1}^{n} {y}_{k}^{2}\end{matrix} ] [ \begin{matrix}{\sum }_{k = 1}^{n} {x}_{k} Mv {y}_{k} \\ {\sum }_{k = 1}^{n} Mv {y}_{k}\end{matrix} ] ,$$
where, Mvx and Mvy, which are global vectors, respectively represent an x-directional motion value and a y-directional motion value, x and y are respectively index values of x and y coordinates of the block, ax and ay are respectively an x-directional zooming factor and a y-directional zooming factor, and bx and by are respectively an x-directional panning factor and a y-direction panning factor.

17. A motion estimator comprising:
a global vector modeling unit for performing regression analysis based on a plurality of motion vectors to determine a global vector calculating formula, and for providing the global vector calculating formula to a candidate vector calculating unit,
wherein the candidate vector calculating unit calculates a global vector for each block of a next frame to be interpolated according to the global vector calculating formula.

18. A computer readable medium having stored thereon instructions for executing a motion estimating method, the instructions comprising:
a first set of instructions for calculating, by a candidate vector calculating unit, a plurality of candidate vectors for each of a plurality of blocks of a frame to be interpolated, on the basis of a current frame and a previous frame;
a second set of instructions for selecting a candidate vector for each of the plurality of blocks from among the plurality of candidate vectors according to a desired criteria:
a third set of instructions for outputting the selected candidate vectors for each of the plurality of blocks as a final motion vector of a corresponding block;
a fourth set of instructions for performing regression analysis based on the final motion vectors to determine a global vector calculating formula; and
a fifth set of instructions for providing the global vector calculating formula to the candidate vector calculating unit,
wherein the calculating the plurality of candidate vectors comprises calculating a global vector for each block of a next frame to be interpolated, according to the global vector calculating formula, and providing the global vector as a candidate vector of the plurality of candidate vectors to the candidate vector deciding unit.
